(19) United States
(12) Patent Application Publication
(10) Pub. No.: US 2025/0371870 A1
(43) Pub. Date: Dec. 4, 2025

(54) ACTION DETECTION IN VIDEOS WITH LOGICAL CONSTRAINTS ON SPEED AND REVERSIBILITY

(71) Applicant: NEC Laboratories America, Inc., Princeton, NJ (US)

(72) Inventors: Deep Patel, Mount Holly, NJ (US); Erik Kruus, Hillsborough, NJ (US)

(21) Appl. No.: 19/219,239

(22) Filed: May 27, 2025

Related U.S. Application Data
(60) Provisional application No. 63/652,320, filed on May 28, 2024.

(51) Int. Cl. G06V 20/40; G06V 10/25; G06V 10/764; G06V 10/776; G06V 10/82

(52) U.S. Cl. CPC G06V 20/41; G06V 10/25; G06V 10/764; G06V 10/776; G06V 20/44; G06V 10/82

(57) ABSTRACT

Systems and methods for action detection are provided. The systems and methods include generating action prediction labels and bounding boxes for objects detected in video frames and comparing the action prediction labels and the bounding boxes with corresponding ground labels, determining a classification loss and a localization loss, and determining a reversibility action loss by comparing the action prediction labels with known actions indices and logical constraints and a speed action loss by comparing the action prediction labels with known actions indices and logical constraints. The systems and methods further include combining the classification loss, localization loss, reversibility action loss, and speed action loss to evaluate a total loss and selecting the action prediction with a lowest total loss as an action assertion and performing reactionary actions in a connected device in response to the action assertion.

### RELATED APPLICATION INFORMATION

This application claims priority to U.S. Provisional Patent Application 63/652,320, filed on May 28, 2024, incorporated herein by reference in its entirety.

### BACKGROUND

### Technical Field

The present invention relates to image and video processing and more particularly to computer vision techniques to set logical constraints on actions in videos.

### Description of the Related Art

Techniques in the prior art often have difficulty identifying actions when the action is reversible or the action is temporally dependent. Actions like walking and running can be identified in artificial intelligence (AI) models as being the same when in actuality the actions are different.

Additionally, reversible actions like parking a car and driving a car that was parked, can be treated the same by the AI model. Failing to accurately identify actions like these based on the reversibility of the action can also affect the AI model's ability to perform a given task.

### SUMMARY

According to an aspect of the present invention, a method is provided for action detection with logical constraints including generating action prediction labels and bounding boxes for objects detected in video frames and comparing the action prediction labels and the bounding boxes with corresponding ground labels to the respective action prediction labels and bounding boxes, and determining a classification loss and a localization loss from the action detection labels and bounding boxes. The method can further include determining a reversibility action loss by comparing the action prediction labels with known actions indices and logical constraints and a speed action loss by comparing the action prediction labels with known actions indices and logical constraints, combining the classification loss, localization loss, reversibility action loss, and speed action loss to evaluate a total loss of the action prediction and selecting the action prediction with a lowest total loss as an action assertion, and performing one or more reactionary actions in a connected device in response to the action assertion.

According to another aspect of the present invention, a system is provided for action detection with logical constraints including a processor and a memory storing computer-readable instructions. When the memory is executed by the processor, the memory causes the system to generate action prediction labels and bounding boxes for objects detected in video frames and comparing the action prediction labels and the bounding boxes with corresponding ground labels to the respective action prediction labels and bounding boxes, and determine a classification loss and a localization loss from the action detection labels and bounding boxes. The memory can further cause the system to determine a reversibility action loss by comparing the action prediction labels with known actions indices and logical constraints and a speed action loss by comparing the action prediction labels with known actions indices and logical constraints, combine the classification loss, localization loss, reversibility action loss, and speed action loss to evaluate a total loss of the action prediction and selecting the action prediction with a lowest total loss as an action assertion, and perform one or more reactionary actions in a connected device in response to the action assertion.

According to another aspect of the present invention, a computer program product comprising a non-transitory computer-readable storage medium containing computer program code, the computer program code when executed by one or more processors causes one or more processors to perform operations. The computer program code comprising instructions to generate action prediction labels and bounding boxes for objects detected in video frames and comparing the action prediction labels and the bounding boxes with corresponding ground labels to the respective action prediction labels and bounding boxes, and determine a classification loss and a localization loss from the action detection labels and bounding boxes. The computer program code further causes the processors to determine a reversibility action loss by comparing the action prediction labels with known actions indices and logical constraints and a speed action loss by comparing the action prediction labels with known actions indices and logical constraints, combine the classification loss, localization loss, reversibility action loss, and speed action loss to evaluate a total loss of the action prediction and selecting the action prediction with a lowest total loss as an action assertion, and perform one or more reactionary actions in a connected device in response to the action assertion.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system using an action detection framework, in accordance with an embodiment of the present invention;

FIG. 2 is a block diagram illustrating the action detection framework in greater detail, in accordance with an embodiment of the present invention;

FIGS. 3-4 are flow diagram illustrating a method for employing the logically constrained action detection framework, in accordance with an embodiment of the present invention;

FIG. 5 is a system for calculating classification loss and localization loss in greater detail, in accordance with an embodiment of the present invention;

FIG. 6 is a system for calculating reverse loss in greater detail, in accordance with an embodiment of the present invention;

FIG. 7 is a system for calculating speed loss in greater detail, in accordance with an embodiment of the present invention;

FIG. 8 is a computer implemented system for executing the action detection framework, in accordance with an embodiment of the present invention; and

FIG. 9 is a block diagram of a neural network, in accordance with an embodiment of the present invention.

### DETAILED DESCRIPTION OF PREFERRED EMBODIMENTS

Action detection within video processing frameworks can identify and classify actions based on a variety of factors. Among these factors are spatial and temporal variations in movement, as well as context of the movement. For example, aside from variations in gaits, walking and running are generally the same motion. Legs alternate in lifting and setting down in front of the remainder of the body, with one foot on the ground at a time. Running is mostly the same motion as walking with few differences mechanically that an artificial intelligence (AI) model may ignore or fail to detect. These two motions can be differentiated by the speed at which the motions occur. Walking is associated with slower movement than running, meaning the two motions can be differentiated by their relative speed instead of other factors that may be less objective.

Many reversible motions can be very similar to each other, with the main difference being the direction in which they are performed. From an third-party perspective, the exchange of possession of a good can be reversible, such as placing an object on a shelf and taking the object from the shelf. To alleviate the problems related to temporally and spatially ambiguous actions, a framework to improve action detection with logical constraints can be useful.

The framework can apply logical constraints to action classification processes to differentiate between similar but reversible actions and actions with different classification dependent on their motion dynamics (speed). Different reversible actions can include push-pull motions, enter-exit motions, place-lift motions, etc. Different temporal motions can include run-walk motions, hit-touch motions, etc. The logical constraints identify actions to prevent similarly action from being identified together.

The action classification framework can be applied to a variety of applications. For example, public safety, manufacturing, retail, and other situations where slight variations can have profound impact on the classification. The framework can identify human motion and poses, or that of other animals or inanimate objects. The framework can identify an emergency situation based on a crowd of people running erratically, instead of walking calming, as is customary. Alternatively, a retail theft protection system can identify a user picking up a product and differentiate this action from the user placing down the product when tracking the goods in a retail space. The context or situation can also provide insights for the framework to more accurately identify an action. For example, in the emergency identification situation, high pitched screams can indicate emergencies more so than a monotone murmur, and for theft protection systems, repeated activity such as several instances of questionable behavior (like potentially taking a good) can weigh towards or against determining a good is being stolen.

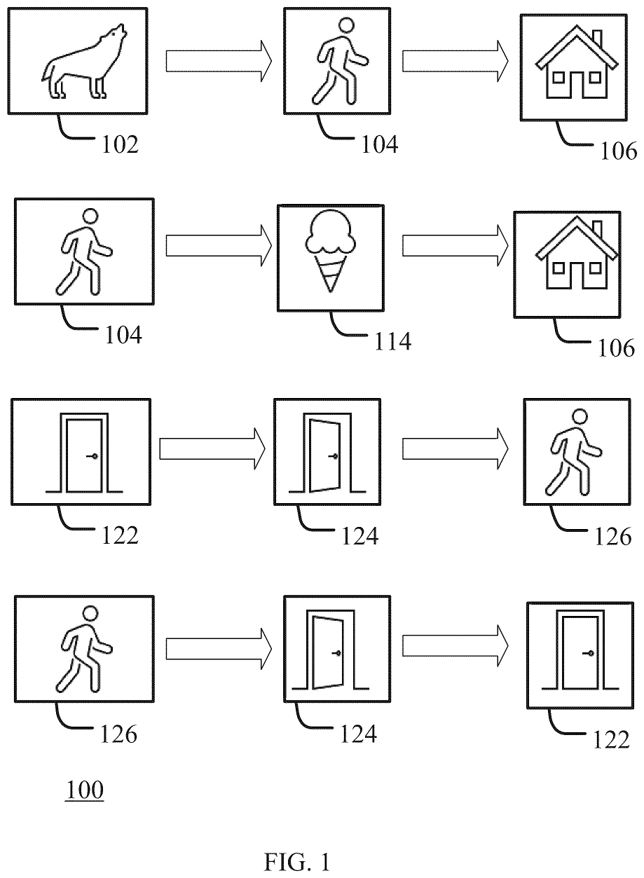

Referring now in detail to the figures in which like numerals represent the same or similar elements and initially to FIG. 1, a block diagram illustration of an action detection within action detection framework 100 is depicted according to an embodiment of the present invention.

Action detection framework 100 can demonstrate a number of different situations that exemplify the differences in reversible action and temporal action. Temporal type action detection can include, e.g., a human 104 entering a house 106. Human 104 can enter house 106 to avoid a potentially dangerous situation caused by a danger 102. Human 104 can move quickly than if human 104 was going to house 106 with a dessert 114. The speed of reaching human 104 can be captured by visual data sensors for classification. Alternative embodiments of the present invention can use other types of sensors such as inertial measurement unit (IMU) sensors that measure acceleration, velocity, and rotation. Other sensors are also contemplated such as connected devices such as Internet of Things (IoT) sensors, and signals from a mobile device such as Wi-Fi®, Bluetooth, and NFC.

Human 104 can be classified as running in the situation where danger 102 is present and walking in the situation where dessert 114 is present. The classification of running or walking can dictate downstream activities such as having emergency services on standby in the case that human 104 is running and causes a home automation to open windows or play music of house 106 in the case that human 104 is walking. The action detection framework 100 can be an integrated into the IoT such as lights, cameras, appliances, computers, mobile phones, etc. Action detection framework 100 can also improve training an action classification model. Using action detection framework 100 can allow for greater integration into IoT or improved emergency services response time among other applications.

Action detection framework 100 can also classify reversible actions. A closed door 122 can be opened such that the door becomes an opened door 124. Exiting open door 124 can be a person 126. This action can also be reversed. The person 126 can enter the opened door 124 and close the door after walking through the door, making the door closed door 122. Since the two states of the door (open and closed) are reversible, misclassification is possible without action detection framework 100. Like temporally different actions, reversible actions can be useful for action detection framework 100 by tracking users' movements more accurately.

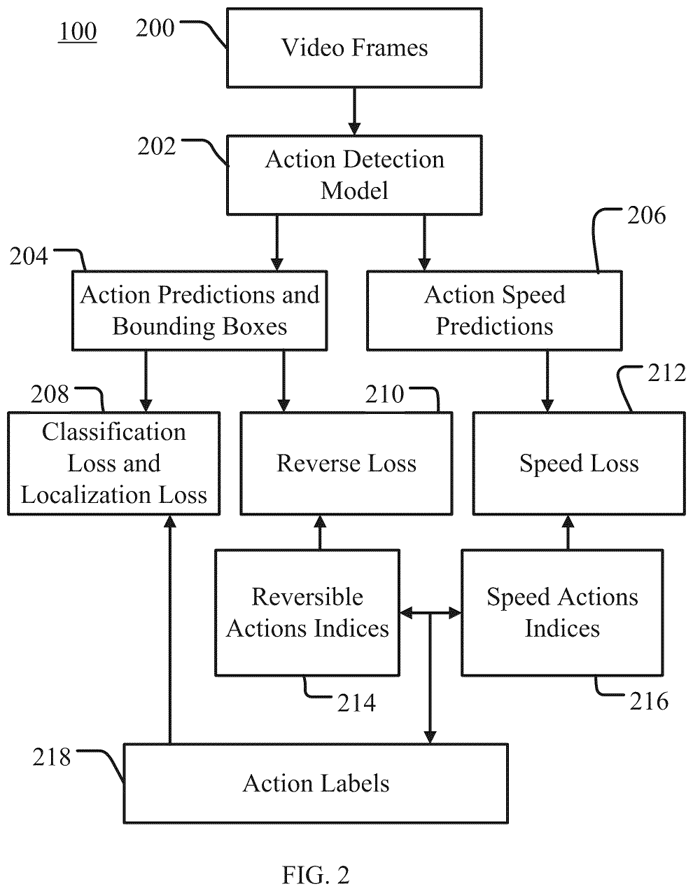

Now referring to FIG. 2, a block diagram of the action detection framework 100 is shown in accordance with an embodiment of the present invention. An action detection model 202 receives video frames 200. These videos can be collected by action detection framework 100 or another source such as publicly available datasets. Action detection model 202 can apply a logical constraint (and determine a corresponding loss) to differentiate between actions that are similar but reversible. In other embodiments of the present invention, the similar but reversible actions can be differentiated with actions that have different speed dynamics, or the speed dynamics can be evaluated without the reversibility of the actions. Action detection model 202 outputs a bounding box with action class predictions 204 and action speed predictions 206 for each person in the video frame. Action detection model 202 can be a transformer, such as a visual transformer or 3D convolutional neural network (CNN). In an embodiment of the present invention action detection model 202 uses the transformer AI architecture to learn motion and semantic patterns in video frames 200. The output of action detection model 202 is a feature map (not depicted) which includes information about the action class in video frames 200. This information can be converted into a probability distribution of a number, N, classes using action class predictions 204. The transformer AI can be built using multi-layer perceptron (MLP) or simple Linear layers.

Action class prediction 204 can be included in action detection framework 100 for action prediction or an intermediate prediction which provides further evaluation based on logical constraints within action detection framework 100 as well as bounding boxes. Action class predictions 204 can also include a bounding box head, action prediction head, and action speed prediction head. These heads can also be implemented with the MLP or linear layer. A head is a component to a multi-head attention module which learns different attention patterns.

The MLP or linear layer can include learnable weight parameters which can transform an input vector from the action detection model into N classes. The action class predictions are obtained from the MLP layer output by applying a softmax function. The MLP layer transforms the N classes shaped vector into a probability distribution where the probability of each of the classes sums to one (1). The predicted class can be selected by applying a confidence threshold to the probability distribution. Other forms and components of AI models are also contemplated for prediction such as graph neural networks (GNNs), recurrent neural networks (RNNs), long short term memory (LSTM), gated recurrent units (GRUs), mixture of experts (MoE), hypernetworks, etc. Action class predictions 204 can be computed by using ground truths and predicted bounding boxes and labels.

In some embodiments of the present invention, the classification loss can be determined through cross-entropy loss and determine the accuracy of the model for correctly identifying the object. Localization loss can be determined by minimizing L2 loss and maximizing the generalized intersection over the union between the ground truth and the predicted bounding boxes and determines the accuracy of the model for correctly identifying the object shape or location. L2 is a technique to prevent overfitting by penalizing large weights. L2, also known as L2 regularization, adds a penalty term to the loss function based on the squared values of the weights. Intersection of union is a method to quantify how two objects, often bounding boxes, overlap. Together the classification loss and localization loss 208 can evaluate action detection model 202.

Reverse loss (reversibility action loss) 210 applies techniques to differentiate reversible actions. The actions are differentiated temporally by using known reversible actions indices 214 from action labels 218. With reversible actions indices 214 and action labels 218, reverse loss 210 guides the predictions from action detection model 202 for the reversible actions to be distinct. In an embodiment of the present invention, reverse loss 210 can be a contrastive loss that encourages the distance between logits to be maximized if the logits are from different classes. The distance is minimized if the logits are from the same class. When training action detection model 202, loss functions can be used to guide action detection model 202 to learn internal parameters that produce the correct class given the ground truth action class for each object in video frames 200.

Reverse loss 210 is an additional loss that enforces further constraints that make action detection model 202 create a better boundary between the reversible classes. This constraint is implemented by minimizing the distance between the logits of the objects instances with same classes and maximizing the distance for different classes. Another way to enforce this is to ensure that the top predictions (e.g., top two (2) or top five (5) predictions) of the action detection model 202 do not contain reversible actions. This prevents reversible actions from being associated with one another and identified together. In other words, if the model predicts reversible actions like push and pull as the top predictions, the loss value will be higher than if one of the reversible actions are predicted. For example, if push was present without pull then the loss value can be lower. This can guide action detection model 202 to understand the constraint and ensure that reversible actions are separated in the output probability distribution.

In another embodiment of the present invention, the reverse loss 210 can penalize action detection model 202 if the top (highest) two predictions are both from the same reversible action reach a threshold. When the sum of the probabilities of the top two predictions for reversible actions exceed some threshold, α, the model can be penalized. In some embodiments of the present invention the threshold can be 0.50. In other embodiments of the present invention this threshold can be higher or lower, such as e.g., 0.9 or 0.4. The threshold can be adjusted according to the magnitude of the probabilities and the level of separation applicable between the reversible actions.

Speed loss (speed action loss) 212 guides action detection model 202 to better differentiate between actions with similar visual appearance but have different motion speeds. Speed loss 212 inputs action speed predictions 206 for each action class predicted by action detection model 202 with known speed action indices 216. Speed action indices 216 receive information from action labels 218. Speed action indices 216 includes actions with similar appearances but different speeds or motion dynamics.

Examples in speed action indices 216 include walk-run, hit-touch, put down-slam, etc. In an embodiment of the present invention, speed loss 212 can be implemented by considering an action speed scale that recognizes the speed and motion differences between different action labels 218 and enforcing the action speed predictions 206 from the action detection model 202 to follow the ground truth speed predictions derived from the scale. Another embodiment of the present invention can have speed loss 212 reward the action detection model 202 when action detection model 202 predicts significantly different speeds for actions with similar appearances. The rewards can also apply to reverse loss 210. When the action speed predictions 206 for similar appearance actions are close, speed loss 212 can apply a penalty. This prevents speed actions from being associated with one another and identified together. The methodology of determining speed loss 212 can be similar, or the same as that for reverse loss 210.

The reverse loss 210 and speed loss 212 can work simultaneously, in tandem, or separately. In an embodiment of the present invention the losses are L2 losses, however in alternative embodiments of the present invention, the losses can be cross-entropy, L1, hinge loss, IoU/GIoU, contrastive loss, focal loss, KL divergence. The reverse loss 210 and speed loss 212 can be different types or the same type.

Additional contextual information can also be applied to action detection model 202 in some embodiments of the present invention such as visual cues such as other objects identified in the video frames 200. Additionally, and/or alternatively, metadata can be included such as time of the timestamps on the video frames 200. For example, action detection framework 100 can be more inclined to identify an emergency if there is running detected at 3:00 AM than if there is running detected at 3:00 PM.

Additional context can include user text input, audio, previous states, etc. For example, applying action detection framework 100 to a boxing match, a previous state can be a guarded stance which provides context that the current state is punching rather than tapping since logically guarding is more closely affiliated with punching than tapping is affiliated with guarding.

Classification loss and localization loss 208, reverse loss 210 and speed loss 212 can be combined. The combined loss can be total loss (not depicted), the lowest total loss can be deemed the action assertion. The action assertion can be the action that action detection framework 100 detects. Action detection framework 100 can perform a reactionary action according to the action assertion. The reactionary action can be notifying authorities or emergency services of an emergency according to the action assertion. In other embodiments of the present invention, action detection framework 100 can interact and engage IoT devices according to the action assertion.

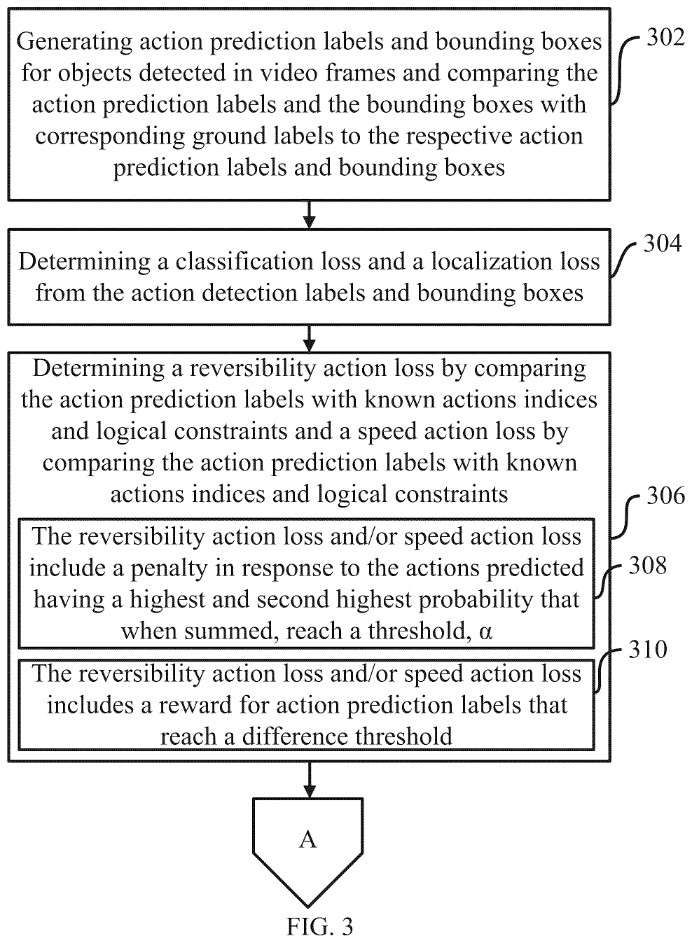

Now referring to FIG. 3 a flow diagram illustrates a method for employing the logically constrained action detection framework according to an embodiment of the present invention. Video frames 200 (FIG. 2) can be processed for temporal data, spatial data, metadata, and contextual data. Temporal data can include the time of each frame in the video frames 200 (FIG. 2). Spatial data can be data around the video frame 200 (FIG. 2), such as distance scales, depth, etc. Metadata can include the creator of the video frames 200 (FIG. 2), location, title, usage, resolution, bitrate, file type, etc. In some embodiments of the present invention, other data can be included such as audio data, previous actions, text input, etc. In block 302, action prediction labels and bounding boxes for objects detected in video frames are generated. Also within block 302, the action prediction labels and the bounding boxes are compared with corresponding ground labels to the respective action prediction labels and bounding boxes. The bounding boxes can be used to identify and track objects over time, which can focus the video frame on a portion or portions of interest instead of analyzing the entire video frame.

In block 304, a classification loss and a localization loss from the action detection labels and bounding boxes are determined. The localization loss can be evaluated using L2 loss and maximizing the generalized intersection of the union ground truth. Classification loss can be computed with cross entropy loss.

In block 306, a reversibility action loss is determined by comparing the action prediction labels with known actions indices and logical constraints. Also within block 306, a speed action loss is determined by comparing the action prediction labels with known actions indices and logical constraints. The known action indices can be a repository, dictionary, database, or another data structure that includes the possible reversible actions. For example, the indices can include push and pull or give and take. The loss can be calculated using contrastive loss. Reversible actions indices 214 are determined based on prior knowledge that certain actions are reversible. For example, if video frames 200 depicts a person entering a room in the reverse, it looks like the person is exiting the room, the same is true for push and pull and open and close actions. Action detection model 202 is trained on these actions with ground truth labels. Similar to the indices for action prediction labels for reversable actions, the indices for action prediction labels for speed actions can be stored in the same or a different data structure. The goal of speed (and reversibility loss) is to enforce the understanding that when predicting a speed (abd reversibility) dependent class, e.g. walk, the probability of another action that is similar at another speed (reversibility), e.g., run, should be minimized.

Embodiments of the present invention can have the AI model trained on fixed number of classes of reversible and speed dependent actions (e.g. 80 or 100 classes of actions such as walk, run, push, pull, etc.). If walk is the first class and run is the second class, the index one (1) and two (2) are in the loss functions. In block 308, the reversibility action loss and/or speed action loss can include a penalty in response to the actions predicted having a highest and second highest probability that when summed, reach a threshold, α Analogously, in block 310, the reversibility action loss and/or speed action loss can include a reward for action prediction labels that reach a difference threshold.

In block 312, the classification loss, localization loss, reversibility action loss, and speed action loss are combined to evaluate a total loss of the action prediction and the action prediction with a lowest total loss as an action assertion can be selected. This loss can be a weighted loss. In block 314, metadata and contextual data can be utilized while generating action prediction labels. The metadata and contextual data can consider other factors to identify an action. The metadata and contextual data can be derived from other portions of the video, alternative sources, manually input, etc.

In block 316, one or more reactionary actions in a connected device is performed in response to the action assertion. The connected device can be internet connected or connected to a local network. The device can be IoT integrated. In block 318, the connected device can track a user with an image capturing device.

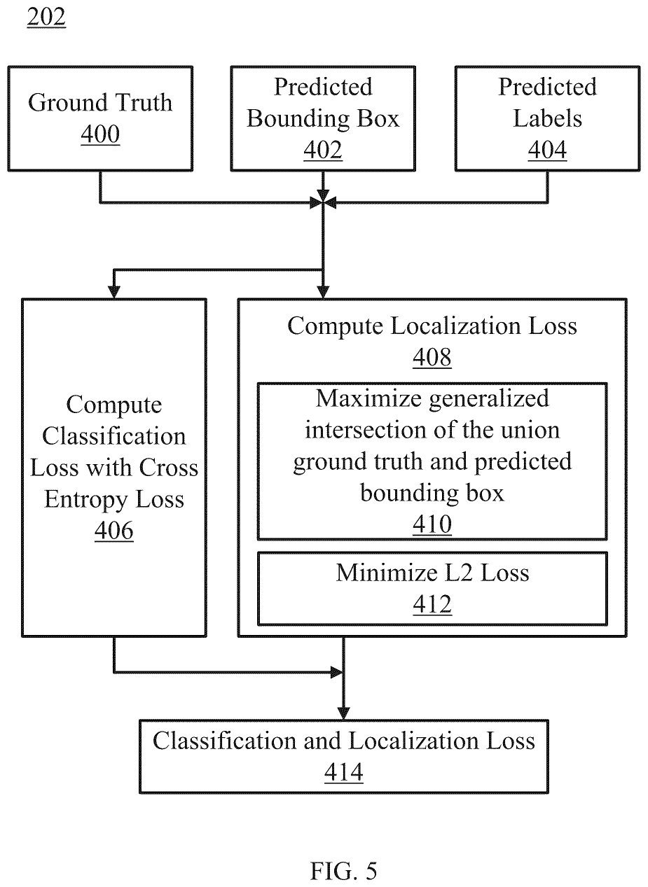

Now referring to FIG. 5, a system for calculating classification loss and localization loss is illustrated according to an embodiment of the present invention. Ground truth 400 is the correct label which action detection framework 100 is attempting to achieve for a given action prediction. Predicted bounding box 402 is a bounding box surrounding the identified object. The bounding box can be in a corners format which defines the corners of a rectangular box where the identified object exists. In other embodiments of the present invention, the bounding box can be a center and size format bounding box. Center and size bounding boxes define a center and the dimensions of the box. The predicted bounding box 402 can apply non-max suppression to remove overlapping predictions of the same object. There can also be anchor boxes which are predefined templates which can be used to identify objects. Predicted labels 404 can be a label generated to classify objects or actions action detection framework 100 is identifying. Ground truth 400 and predicted labels 404 can be compared which can result in the determination of action detection framework 100 classification and localization loss.

The actual objects and actions affiliated with ground truth 400 and the predicted bounding box 402 and predicted labels 404 can determine the efficacy of the model. Ground truth 400 and predicted labels 404 can determine classification loss 406 with cross entropy loss. Alternatives to cross entropy loss in some embodiments of the present invention can include label smoothing, hinge loss, squared hinge loss, focal loss, KL divergence, contrastive loss, dice loss, ArcFace/CosFace, information gain loss, etc.

Ground truth 400 and predicted bounding box 402 can be combined to compute localization loss 408. An objective of localization loss 408 can be to maximize the generalized intersection of the union 410 of ground truth 400 and predicted bounding box 402. Additionally, maximizing localization loss 408 can include minimizing L2 loss 412. Classification loss 406 and localization loss 408 can be combined to form classification and localization loss 414. The combination of losses can be performed by a weighted sum of the losses. The weighting of the losses can be manual, normalized by a scale, dynamic weighting, learnable weights, etc.

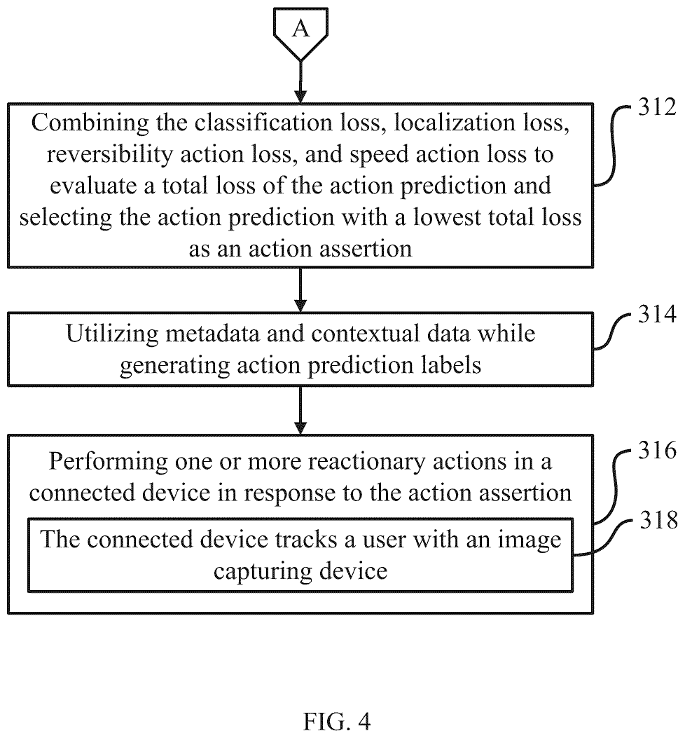

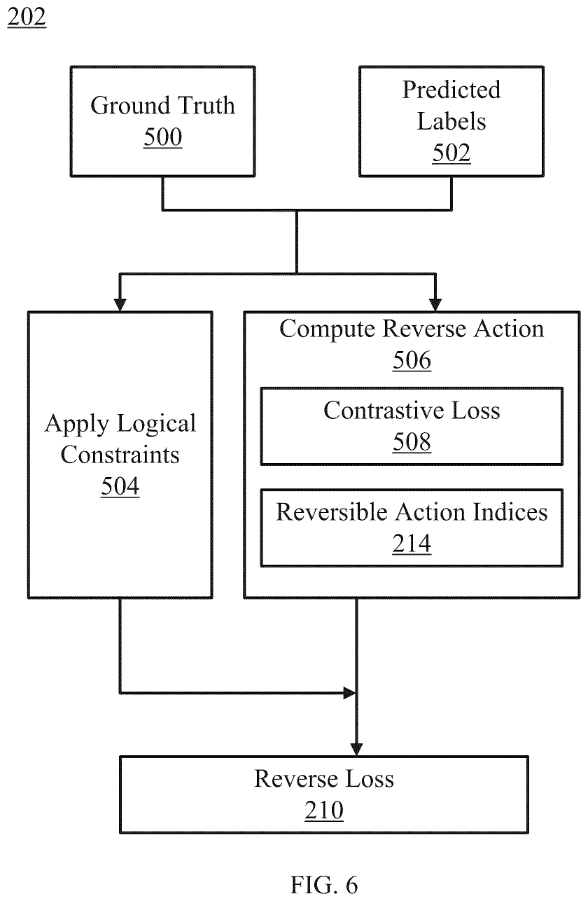

Now referring to FIG. 6, a system for calculating reverse loss is illustrated according to an embodiment of the present invention. Similar to FIG. 4, ground truth 500 and predicted labels 502 are compared to eventually produce reverse loss 210. Ground truth 500 and predicted labels 502 compute reverse action 506 which includes contrastive loss 508 and reversible action indices 214. The difference between the top two (2) predicted labels 502 which are affiliated with actions can be compared with contrastive loss 508. If the reversible actions indices 214 and logical constraints 504 identify these top two (2) results as similar, then reverse loss 210 penalizes the result. The value of the loss function can be defined as the sum of the probabilities of the top two (2) reversible classes.

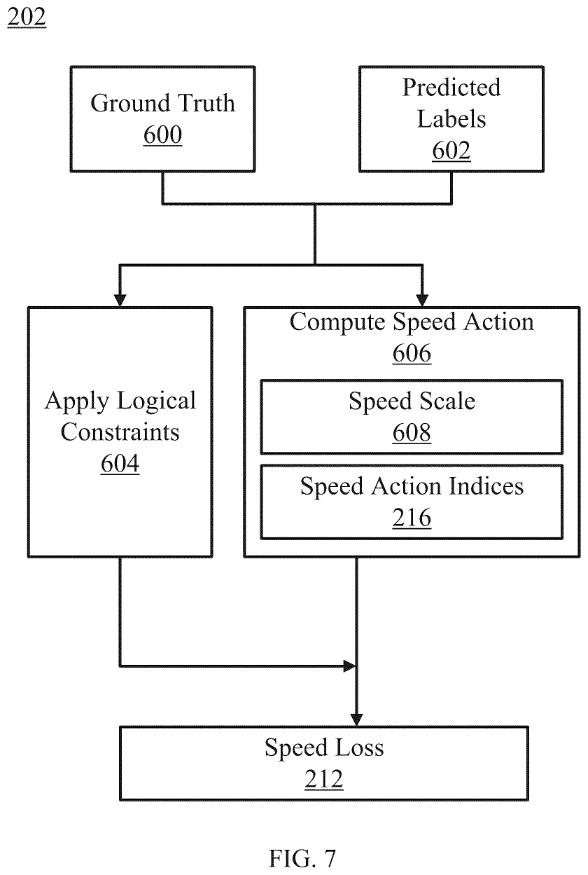

Now referring to FIG. 7, a system for calculating speed loss is illustrated according to an embodiment of the present invention. Similar to FIGS. 4 and 5, ground truth 600 and predicted labels 602 are compared to eventually produce speed loss 212. Ground truth 600 and predicted labels 602 compute speed action 606 which includes speed scale 608 and speed action indices 216. Compute speed action 606 can consider the speed scale of the predicted labels 602 affiliated with the speed action and view the speed scale 608. The difference between the top two predicted labels 602 which are affiliated with actions can be compared in speed scale 608. If the speed actions indices 216 and logical constraints 604 identify these top two (2) results as similar speeds, then speed loss 212 can penalize the result. In other embodiments of the present invention, if predicted labels 602 are not similar when similar logical constraints 604 is applied, a reward can be applied. After applying the penalty the speed loss 212 can be determined. Speed loss 212 is based on prior knowledge of the speed of the motion in each action in video frames 200. In an embodiment of the present invention this can be implemented similarly to reverse loss 210.

Speed loss 212 can penalize action detection model 202 if the top two (2) similar classes only differ in speed of motion (e.g., walk and run, touch and hit) are predicted and the prediction probability sum is greater than a threshold. Like reverse loss 210, speed loss 212 can also penalize if the prediction are in another amount of similarity like within the top five (5) or top (10) instead of top two (2).

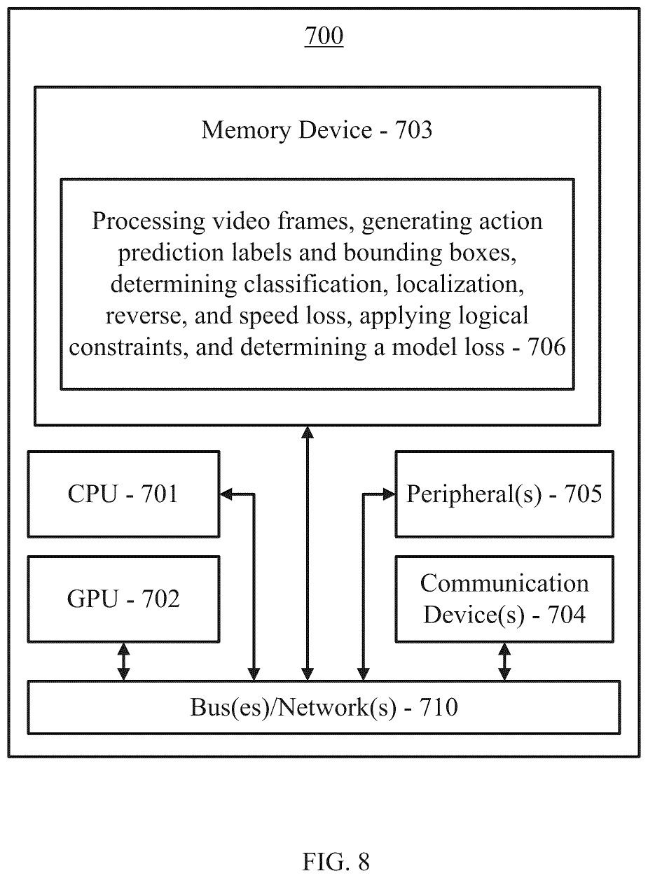

Referring to FIG. 8, a block diagram is shown for an exemplary processing system 700, in accordance with an embodiment of the present invention. The processing system 700 includes a set of processing units (e.g., CPUs) 701, a set of GPUs 702, a set of memory devices 703, a set of communication devices 704, and a set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., Wi-Fi®, etc.) adapters, etc.). The peripherals 705 can include a display device, a user input device, a printer, an imaging device, and so forth. Elements of processing system 700 are connected by one or more buses or networks (collectively denoted by the figure reference numeral 710).

In an embodiment, memory devices 703 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 703 store program code or software 706 for implementing one or more functions of the systems and methods described herein for processing video frames, generating action prediction labels and bounding boxes, determining classification, localization, reverse, and speed loss, applying logical constraints, and determining a model loss. The memory devices 703 can store program code for implementing one or more functions of the systems and methods described herein.

Of course, the processing system 700 may also include other elements (not shown), as readily contemplated by one of skill in the art, as well as omitting certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 700.

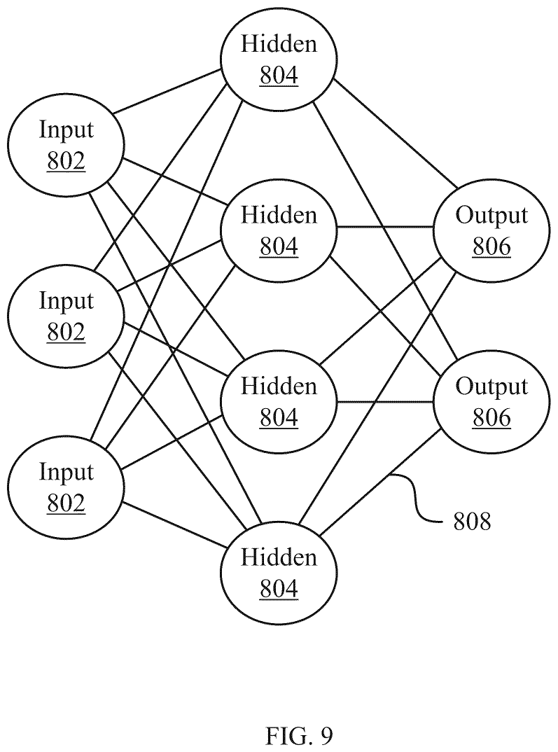

Referring now to FIG. 9, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be back propagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weighted connection 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for action detection with logical constraints, comprising:
generating action prediction labels and bounding boxes for objects detected in video frames and comparing the action prediction labels and the bounding boxes with corresponding ground labels to the respective action prediction labels and bounding boxes;
determining a classification loss and a localization loss from the action detection labels and bounding boxes;
determining a reversibility action loss by comparing the action prediction labels with known actions indices and logical constraints and a speed action loss by comparing the action prediction labels with known actions indices and logical constraints;
combining the classification loss, localization loss, reversibility action loss, and speed action loss to evaluate a total loss of the action prediction and selecting the action prediction with a lowest total loss as an action assertion; and
performing one or more reactionary actions in a connected device in response to the action assertion.

2. The method of claim 1, wherein the reversibility action loss includes a penalty in response to the actions predicted having a highest and second highest probability that when summed, reach a threshold, α.

3. The method of claim 1, wherein the speed action loss includes a penalty in response to the actions predicted having a highest and second highest probability that when summed, reach a threshold, α.

4. The method of claim 1, wherein the speed action loss includes a reward for action prediction labels that reach a difference threshold.

5. The method of claim 1, further comprising:
utilizing metadata and contextual data while generating action prediction labels.

6. The method of claim 1, wherein the connected device tracks a user with an image capturing device.

7. The method of claim 1, wherein the connected device notifies emergency services in response to the action assertion indicating danger.

8. A system for action detection with logical constraints, comprising:
a processor; and
a memory storing computer-readable instructions that, when executed by the processor, cause the system to:
generate action prediction labels and bounding boxes for objects detected in video frames and comparing the action prediction labels and the bounding boxes with corresponding ground labels to the respective action prediction labels and bounding boxes;
determine a classification loss and a localization loss from the action detection labels and bounding boxes;
determine a reversibility action loss by comparing the action prediction labels with known actions indices and logical constraints and a speed action loss by comparing the action prediction labels with known actions indices and logical constraints;
combine the classification loss, localization loss, reversibility action loss, and speed action loss to evaluate a total loss of the action prediction and selecting the action prediction with a lowest total loss as an action assertion; and
perform one or more reactionary actions in a connected device in response to the action assertion.

9. The system of claim 8, wherein the reversibility action loss includes a penalty in response to the actions predicted having a highest and second highest probability that when summed, reach a threshold, α.

10. The system of claim 8, wherein the speed action loss includes a penalty in response to the actions predicted having a highest and second highest probability that when summed, reach a threshold, α.

11. The system of claim 8, wherein the speed action loss includes a reward for action prediction labels that reach a difference threshold.

12. The system of claim 8, further causes the system to:
utilize metadata and contextual data while generating action prediction labels.

13. The system of claim 8, wherein the connected device tracks a user with an image capturing device.

14. The system of claim 8, wherein the connected device notifies emergency services in response to the action assertion indicating danger.

15. A computer program product comprising a non-transitory computer-readable storage medium containing computer program code, the computer program code when executed by one or more processors causes the one or more processors to perform operations, the computer program code comprising instructions to:
generate action prediction labels and bounding boxes for objects detected in video frames and comparing the action prediction labels and the bounding boxes with corresponding ground labels to the respective action prediction labels and bounding boxes;
determine a classification loss and a localization loss from the action detection labels and bounding boxes;
determine a reversibility action loss by comparing the action prediction labels with known actions indices and logical constraints and a speed action loss by comparing the action prediction labels with known actions indices and logical constraints;
combine the classification loss, localization loss, reversibility action loss, and speed action loss to evaluate a total loss of the action prediction and selecting the action prediction with a lowest total loss as an action assertion; and
perform one or more reactionary actions in a connected device in response to the action assertion.

16. The computer program product of claim 15, wherein the reversibility action loss includes a penalty in response to the actions predicted having a highest and second highest probability that when summed, reach a threshold, α.

17. The computer program product of claim 15, wherein the speed action loss includes a penalty in response to the actions predicted having a highest and second highest probability that when summed, reach a threshold, α.

18. The computer program product of claim 15, wherein the speed action loss includes a reward for action prediction labels that reach a difference threshold.

19. The computer program product of claim 15, further causing the processor to:
utilize metadata and contextual data while generating action prediction labels.

20. The computer program product of claim 15, wherein the connected device tracks a user with an image capturing device.
